(19) United States
(12) Patent Application Publication
(10) Pub. No.: US 2026/0056965 A1
(43) Pub. Date: Feb. 26, 2026

(54) APPARATUSES AND METHODS FOR FACILITATING AN INFORMATION MINER USING LANGUAGE MODELS

(71) Applicant: JPMorgan Chase Bank, N.A., New York, NY (US)

(72) Inventors: Bhagyashree Chaudhuri, Iselin, NJ (US); Satishkumar Pilla, Bengaluru (IN); Girish Sirapu, Hyderabad (IN); Maria Beltran, Chicago, IL (US)

(73) Assignee: JPMorgan Chase Bank, N.A., New York, NY (US)

(21) Appl. No.: 18/906,214

(22) Filed: Oct. 4, 2024

(30) Foreign Application Priority Data
Aug. 22, 2024 (IN) 202411063452

(51) Int. Cl. G06F 16/2458; G06F 40/40

(52) U.S. Cl. CPC G06F 16/2465; G06F 40/40

(57) ABSTRACT

Aspects of the subject disclosure may include, for example, obtaining a model, obtaining a document, processing the document based on the model, the processing of the document resulting in a classification of a type of the document, generating, based on the classification of the type of the document, a first output, the first output including a first summary of content of the document along with a capability to answer any cadence queries based on document type and any free text query from a user, and transmitting the first output to a first communication device. Other aspects are disclosed.

### CROSS-REFERENCE TO RELATED APPLICATIONS

The instant application claims priority to India patent application No. 202411063452, filed on Aug. 22, 2024. All sections of the aforementioned application(s) are incorporated herein by reference in their entirety.

### FIELD OF THE DISCLOSURE

The subject disclosure relates to apparatuses and methods for facilitating an information miner using language models.

### BACKGROUND

As the world increasingly becomes connected via vast communication networks and systems and via various types/kinds of communication devices, additional opportunities are created/generated to provision services and applications that enable a wide range of functionalities and capabilities. Within a given environment (e.g., an enterprise, a business, an organization, etc.), there are tasks associated with processing large amounts of information and data, such as structured and unstructured data. Further, such processing may need to occur on a periodic basis (e.g., daily), or in response to events or changes in one or more conditions or circumstances. The amount of effort and cost to efficiently and timely process the information/data represents a significant investment. Moreover, conventional techniques for processing information/data tend to be error prone, which can lead to a host of issues (e.g., inconsistencies between platforms, operational costs exceeding budgetary constraints, delay in output data/information resulting from the processing, etc.).

As the foregoing discussion demonstrates, there is an imperative need for improvements in information processing and handling. While various technologies, such as artificial intelligence and machine learning, have aided in the processing of information/data, those technologies often lack the flexibility and nuance/sophistication to efficiently and accurately handle information/data processing tasks for a given application or environment. Moreover, the use of such technologies is often accompanied by cost in the form of expensive licensing fees/subscriptions, making their use impractical in many situations.

### SUMMARY OF THE DISCLOSURE

One or more aspects of the subject disclosure may include, in whole or in part, obtaining a model; obtaining a document; processing the document based on the model, the processing of the document resulting in a classification of a type of the document; generating, based on the classification of the type of the document, a first output, the first output including a first summary of content of the document; and transmitting the first output to a first communication device. In some embodiments, the first summary of the content of the document is based on an identification of the first role of the first user within an organization. In some embodiments, the second summary of the content of the document is based on an identification of the second role of the second user within the organization, the second role being different from the first role. In some embodiments, the transmitting of the first output to the first communication device causes the first communication device to present the first output, store a copy of the first output, or a combination thereof. Aspects of this disclosure may further include, in whole or in part, based on the classification of the type of the document, transmitting a query to the first communication device; and obtaining, from the first communication device, an answer to the query, wherein the generating of the first output is based on the answer. Aspects of this disclosure may further include, in whole or in part, obtaining, from the first communication device, a query; and generating an answer to the query based on the processing of the document. In some embodiments, the query is a free text query, the answer is based on the type of the document, or a combination thereof. In some embodiments, the answer is included as part of the first output, a third output that is transmitted to the first communication device, or a combination thereof. Aspects of this disclosure may further include, in whole or in part, generating a justification or an explanation for the answer, wherein the justification or the explanation is included as part of the first output, the third output, or the combination thereof. In some embodiments, the processing of the document occurs in less than five minutes and the document is greater than 250 pages, and wherein the processing of the document extracts information that is context seated within text. Aspects of this disclosure may further include, in whole or in part, subsequent to the transmitting, obtaining feedback from the first communication device based on the first output; and modifying the model based on the feedback, the modifying resulting in a modified model. In some embodiments, the feedback modifies the first output, resulting in a modified output that is different from the first output. Aspects of this disclosure may further include, in whole or in part, obtaining a second document; generating, based on the modified model, a third output, the third output including a third summary of content of the second document; and transmitting the third output to the first communication device, the second communication device, a third communication device, or any combination thereof. Aspects of this disclosure may further include, in whole or in part, processing the second document based on the modified model, the processing of the second document resulting in a second classification of a type of the second document, wherein the generating of the third output is based on the second classification of the type of the second document. Aspects of this disclosure may further include, in whole or in part, formatting the first output based on a capability of the first communication device, the formatting resulting in a formatted first output, wherein the transmitting of the first output comprises transmitting the formatted first output.

One or more aspects of the subject disclosure may include, in whole or in part, obtaining a document; determining that a first portion of the document includes structured data and a second portion of the document includes unstructured data; processing, based on the determining, the first portion of the document using a first model to generate a first output; processing, based on the determining, the second portion of the document using a second model to generate a second output; and transmitting the first output and the second output. In some embodiments, the processing of the second portion includes condensing content associated with the unstructured data. In some embodiments, the processing of the first portion includes identifying a type of the document, summarizing content of the document, answering a set of cadence queries based on the type of the document, and answering a free text query obtained from a communication device

One or more aspects of the subject disclosure may include, in whole or in part, obtaining, by a processing system including a processor, at least one input; processing the at least one input to generate an output; providing the output to a user equipment; receiving, based on the providing of the output, a query from the user equipment; analyzing the query via a model to generate an answer to the query; and providing the answer to the user equipment. In some embodiments, the at least one input includes a document, an audio file, a video file, an image, text, an e-mail, an instant message, a table, and a graph, wherein the processing of the at least one input utilizes the model, a second model, or a combination thereof, wherein the output includes a summary of content along with deep seated information and information from data tables of the at least one input, and wherein the summary is based on a role of a user associated with the user equipment.

The various aspects and features described above may be utilized in various combinations with one another in various embodiments of this disclosure. In some embodiments, a computer apparatus for facilitating an information using an information miner using a language model is provided or obtained. The computer apparatus may include a processing system including a processor and a memory that stores executable instructions that, when executed by the processing system, facilitate performance of operations. The operations may effectuate one or more of the features or aspects described herein.

Various embodiments of this disclosure may include or utilize a non-transitory computer readable storage medium for facilitating an information using an information miner using a language model. The storage medium may comprise executable instructions which, when executed by a processing system including a processor, facilitate performance of operations. The operations may effectuate one or more of the features or aspects described herein.

Various embodiments of this disclosure may include or utilize a method for facilitating an information using an information miner using a language model. The method may effectuate one or more of the features or aspects described herein.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a system for generating outputs based on inputs in accordance with miner components that are based on models.

FIGS. 2A-2C depict block diagrams of systems for implementing miner components in accordance with various aspects of this disclosure.

FIG. 2D depicts an illustrative embodiment of a method in accordance with various aspects described herein.

FIG. 3 is a block diagram of an example, non-limiting embodiment of a computing environment in accordance with various aspects described herein.

### DETAILED DESCRIPTION

The subject disclosure describes, among other things, illustrative embodiments for processing and classifying inputs of various types/kinds using models (e.g., large language models, or variants thereof) to generate outputs and answer queries. Other embodiments are described in the subject disclosure.

By way of introduction, aspects of this disclosure may be used to reduce an amount of manual work or overhead in relation to a processing of data or information for one or more purposes (e.g., report generation, resource management, etc.). Aspects of this disclosure may utilize modeling/models to provide, realize, or obtain a data or information miner that may be used to collect, extract, and/or generate data or information suitable for one or more purposes. In some embodiments, a toolset or tool suite may be generated or provided that includes an extractive miner, an abstractive miner, and/or a structured or table information miner, as described in further detail below.

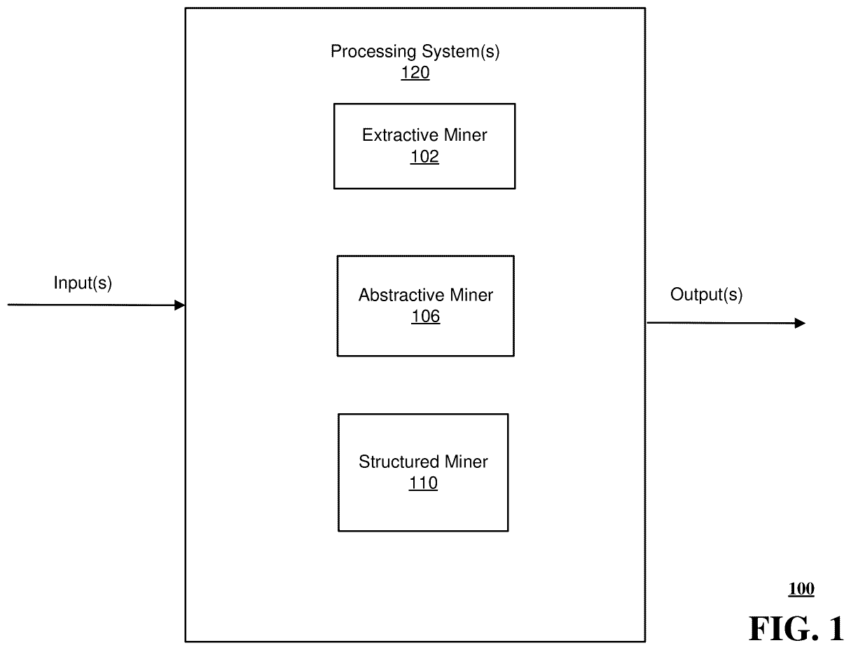

Referring now to FIG. 1, a block diagram illustrating an exemplary, non-limiting embodiment of a system 100 in accordance with various aspects described herein is shown. The system 100 may include a number of entities, such as an extractive miner 102, an abstractive miner 106, and a structured miner 110. Taken individually and/or collectively, the entities shown in FIG. 1 may be implemented via one or more processing systems 120, where a given processing system may include one or more processors. The processing system(s) 120 may obtain one or more inputs (illustratively shown in FIG. 1 as Input(s)) and may process the same to generate one or more outputs (illustratively shown in FIG. 1 as Output(s)). The system 100 of FIG. 1 is exemplary of a particular type/kind of environment where aspects of this disclosure may be applied or implemented, with the understanding that other types/kinds of environments may be utilized or provided.

Each of the entities of FIG. 1 may be utilized based on a determination of whether the input(s) include structured or unstructured data or information. The extractive miner 102 may provide for a number of objectives or functionalities as part of numerous practical applications, such as identifying a type of document provided as input, summarizing document content, answering queries relevant to the document (e.g., providing answers to frequently asked questions for the type/kind of document that is at hand), and/or answering any free text queries. The abstractive miner 106 may provide for a number of objectives or functionalities as part of numerous practical applications, such as obtaining, extracting, or condensing information from documents (e.g., large documents exceeding 250 pages), precisely answering queries via one or more responses, and/or reducing the amount of time or labor needed to solicit or obtain information/data. The structured miner 110 may provide for a number of objectives or functionalities as part of numerous practical applications, such as obtaining information/data from tables using free text queries, reducing the time taken to understand patterns or behaviors across sets of information/data, and/or creating/generating narratives or summaries to enable/provide reporting at different layers of abstraction, potentially as a function of an identification of a role within an organization (e.g., quick glance perspectives to provide an executive summary, more nuanced perspectives to facilitate human resource or project management activities, anomaly reporting to identify potential issues or problems such as security flaws or vulnerabilities, etc.). Additionally, results from structed miner 110 can also be used to validate the output from extraction miner 102 based on the business use case.

In embodiments involving practical applications, the extractive miner 102 may be used to understand data or information included as part of the input(s). A type or kind of document that may be included as part of the input(s) may serve as a starting point for leveraging a language model capability set. The extractive miner 102 works towards invoking any cadence question set which may need to be answered based on the document classification that is done. The extractive miner 102 may summarize content of the document and answer any queries relevant to the document, potentially inclusive of any queries posed on the fly or in real time. In this regard, one or more modeling techniques or models may be utilized or invoked by the extractive miner 102 to: identify the type/kind of document, summarize content of the document, provide/generate responses to queries, and/or enable corrections or clarifications. The extractive miner 102 may assist in obtaining information from large documents by providing extractions in less time (such as on the order of minutes—e.g., 5 minutes or less) than would be possible via manual or human/user techniques. Further, the extractive miner 102 may enhance qualities in analysis by providing an ability to fine-tune models with use or user feedback. The extractive miner 102 may be particularly useful in relation to input(s) that include semi-structured/unstructured data or involve data needing cadence overview. In some embodiments, the extractive miner 102 may by supported by various models, such as Robustly Optimized BERT Pre-training Approach (also referred to in the art as ROBERTa), and any variants thereof (e.g., Roberta-squad2) and/or Pre-trained with Extracted Gap-sentences for Abstractive Summarization (also referred to in the art as Pegasus).

In embodiments involving practical applications, the abstractive miner 106 may process the input(s) to generate enhanced resolution or visibility into the information, data, or content at hand. For example, the abstractive miner 106 may screen sentences, paragraphs, or the like to identify and extract noteworthy or relevant words, phrases, or expressions, potentially relative to a query at hand. The abstractive miner 106 may aggregate any such words, phrases, or expressions and may apply cognition/cognitive capabilities to feed them into Open sourced large language models (LLMs), like llama2-7B, as part of context to enable the model to generate response to questions. The abstractive miner 106 may be particularly useful in relation to input(s) that include unstructured data or information. In some embodiments, the abstractive miner 106 may by supported by various models, such as one or more open source large language models (e.g., llama 2-7B).

In embodiments involving practical applications, the structured miner 110 may process the input(s) to create narratives or summaries as described above. In terms of approach or methodology, the structured miner 110 may utilize one or more models/modeling techniques to recognize data or information that may be included as part of one or more tables (e.g., data tables). In some instances, the structured miner 110 may provide or utilize a structured query language (SQL) to manage data or information that may be sourced via a free text query. The structured miner 110 may interface with one or more dashboards, platforms, or the like, to facilitate user interfaces and user interactions. In some embodiments, the structured miner 110 may be used to train a model (e.g., a llama 2-7B model) to recognize a data table (or the like) and produce SQL data/information against a free text query, which helps in mining the requisite information from the data tables.

While shown and described above separately, aspects or functionalities of the extractive miner 102, the abstractive miner 106, and/or the structure miner 110 may be utilized in conjunction with one another.

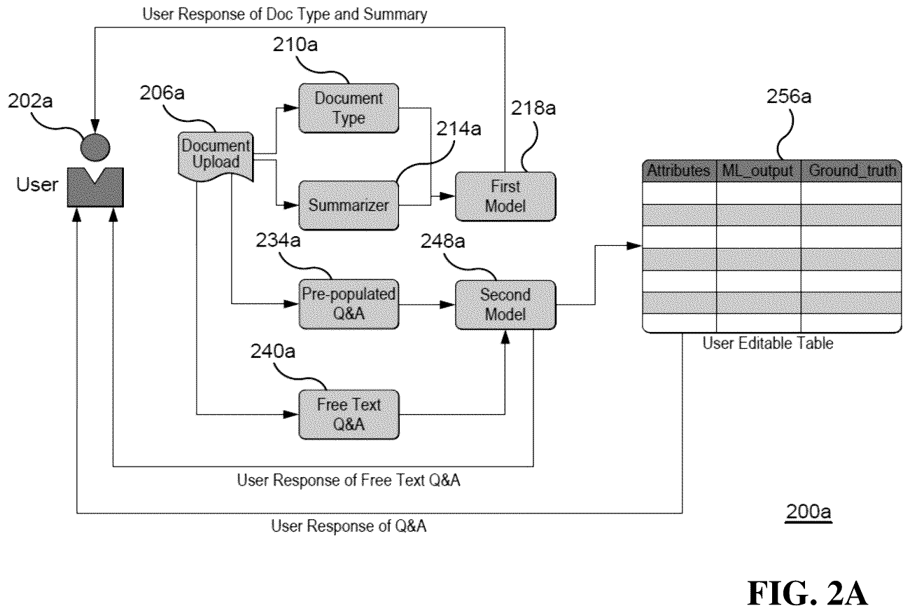

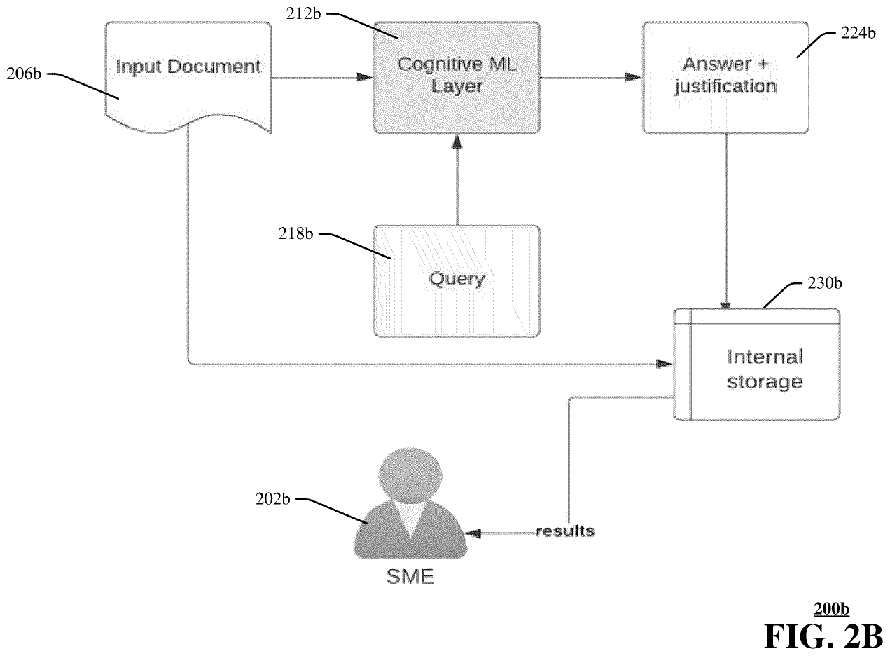

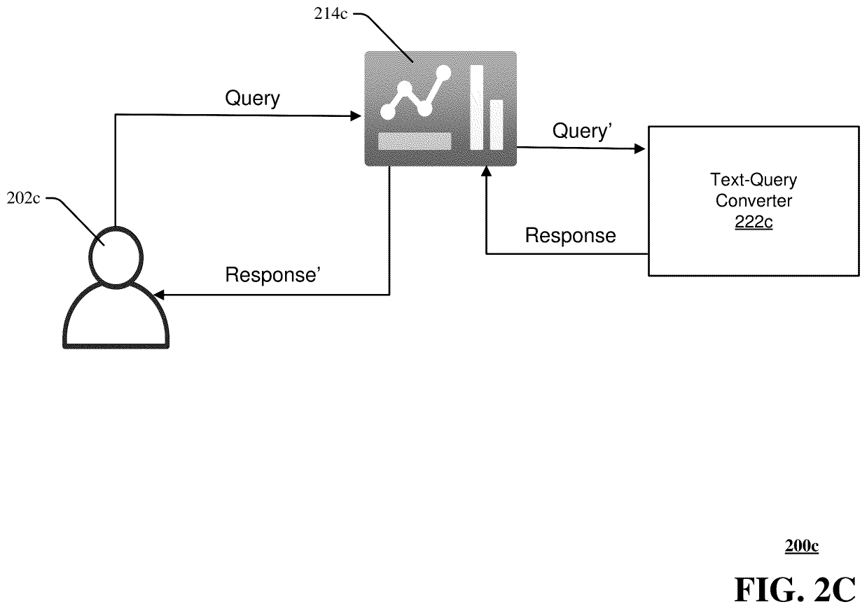

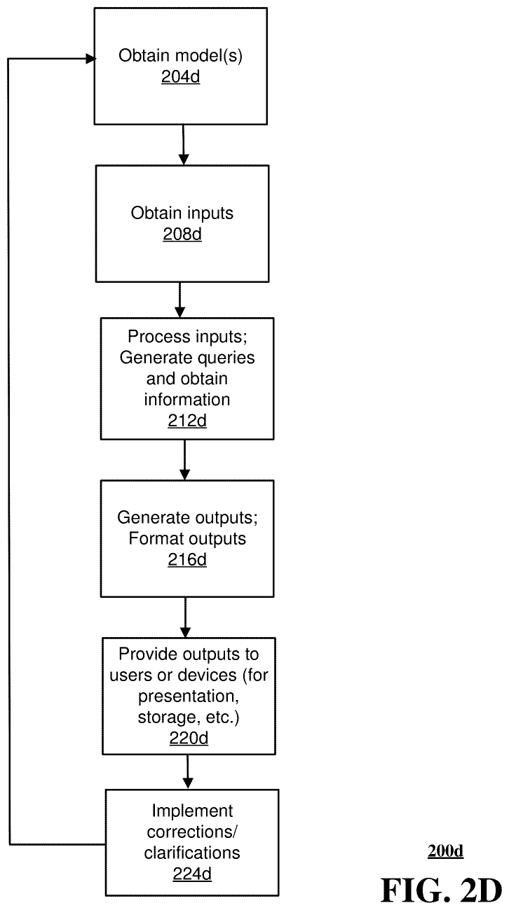

Referring now to FIG. 2A, a process flow is shown/superimposed in respect of a system 200a. In some embodiments, aspects of the system 200a may correspond to the extractive miner 102 of FIG. 1. In operation, a user 202a may upload a document 206a (where the document 206a may be included as part of the input(s) of FIG. 1). The document 206a may be classified in accordance with a document kind or type 210a, and content of the document 206a may be summarized via a summarizer 214a. The classification of the document 206a and the summarization via the summarizer 214a may serve as input to a model 218a (e.g., a first model, such as a cognition model based on Pegasus), which may be useful from a perspective of providing information to the user 202a.

The document 206a may be subject to analysis to generate pre-populated questions and answers (Q&As) 234a and/or free text Q&As 240a. In this context, it may be the case that a certain number of Q&As may be considered to be basic or standard as part of the document 206a at hand (e.g., name, address, birthdate, etc.), applicable to the Q&As 234a. On the other hand, other Q&As may be more of a free-form nature (such as, for example, the user 202a inquiring as to the turn-around time of a loan application or desires some specific off-cadence information pertaining to a particular document then that may be more readily applicable to Q&As 240a), that may be more readily applicable to the Q&As 240a. The Q&As 234a and/or the Q&As 240a may serve as input to a model 248a (e.g., a second model, such as a ROBERTa model, or any variant thereof), which may be useful from a perspective of providing information to the user 202a. In some embodiments, the model 248a may be used to generate an output table or chart, such as the table 256a. Illustratively, the table 256a is shown as being organized or arranged with various types or kinds of information, such as attributes, machine learning (ML) output, and ground truth. The user 202a may have an ability to edit information/data contained within the table 256a, potentially subject to one or more authorization or permission-based schemes. In some embodiments, records or logs may be utilized to keep track of edits or changes made over time, which may be useful for enhancing model accuracy and improving its performance.

Referring now to FIG. 2B, a process flow is shown/superimposed in respect of a system 200b. In some embodiments, aspects of the system 200b may correspond to the abstractive miner 106 of FIG. 1. In operation, a document 206b may be obtained and may correspond to input to a cognitive machine learning (ML) layer which may be powered by open source LLM like llama2-7B or model 212b. The model 212b may be operative on/upon the document 206b in conjunction with one or more queries (see, e.g., query 218b), to generate or retrieve one or more answers and justifications or explanations for the answer(s)/retrievals 224b. The document 206b and/or the answers—and—justifications 224b may be stored as part of/in conjunction with a storage 230b. Further, the document 206b and/or the answers-and-justifications 224b may be provided as results to a user 202b (potentially via one or more interfaces, such as an interface supportive of a subject matter expert (SME)).

Referring now to FIG. 2C, a process flow is shown/superimposed in respect of a system 200c. In some embodiments, aspects of the system 200c may correspond to the structured miner 110 of FIG. 1. In operation, a user 202c may furnish or provide a query via a dashboard 214c (or other interface). The query, as potentially subject to modification or formatting via the dashboard 214c (as represented in FIG. 2C as query′), may be forwarded to a text-query converter 222c. The converter 222c may analyze the query (or, analogously, query′) to generate a response. The converter 222c may provide the response to the dashboard 214c, information from the dashboard 214c may be directly consumed by the user 202c, potentially in accordance with a capability of an associated communication device. The response′ may include or contain any insights, such as quick glimpses into details within charts or graphs that may be included or presented as part of the dashboard 214c that might otherwise require manual understanding or derivation.

In some embodiments, aspects of parameter efficient fine-tuning (PEFT) may be utilized to facilitate a fine-tuning or tailored approach towards large language models, in connection with the structured miner component primarily. This fine-tuning would help the model to generate stable and comprehensive SQL from free text which otherwise may be cumbersome, especially when the model is dealing in/with huge and heterogenous datasets. PEFT may involve a balancing of computational efficiency and task performance, while making it feasible to fine-tune even the largest large language model without sacrificing quality or accuracy. PEFT may assist with reducing (e.g., minimizing) storage cost, memory usage, and latency.

As described above, aspects of this disclosure may be utilized as part of practical applications involving various types or kinds of data, information, content, and the like. For example, and in relation to a practical application involving financial technology (‘fintech’), various types of documents that may be subject to analysis, potentially as part of one or more line of business units, may include know your customer (KYC) documents, wholesale lending services (WLS) documents, middle office (MO) documents, and the like. Such documents may be subject to analysis via one or more of the systems, devices, and components set forth herein. Of course, other departments of a business or organization may be supported via the aspects of this disclosure, such as for example human resources, billing/payroll, manufacturing, shipping, and the like. Indicators or identifiers of roles within an organization (or the like) may play a role in various functions or outputs set forth herein.

Referring now to FIG. 2D, an illustrative embodiment of a method 200d in accordance with various aspects described herein is shown. In block 204d, one or more models may be obtained. For example, the obtaining of the model(s) as part of block 204d may include generating the model(s) and/or acquiring the model(s) (and potentially modifying one or more of the acquired model(s)). The generation or modifying of the model(s) may include providing/obtaining one or more sets of samples. Based on the provided set(s) of samples, the model(s) may be trained or adapted.

In block 208d, one or more inputs may be obtained. The inputs may include data, information, content, or the like. The inputs may be formatted as, or include, documents, audio files, video files, images, text, messages (e.g., e-mails, instant messages), tables, graphs, etc. In some instances, the inputs may include user-generated inputs, such as queries or questions, answers, statements, etc.

In block 212d, the inputs of block 208d may be processed. For example, the processing of block 212d may be based on an application of the inputs of block 208d to one or more of the models of block 204d. Based on the processing of block 212d, one or more queries may be generated or spawned that may serve to solicit additional information. The additional information may be obtained from one or more sources, such as an online record or database, a user or operator, etc. Based on the additional information, additional processing may be performed. In this respect, aspects of the block 212d may be executed iteratively or repeatedly as additional information (or, analogously, additional data or content) is obtained.

In block 216d, one or more outputs may be generated. The outputs of block 216d may be based on the processing of block 212d. The outputs of block 216d may be organized or arranged in accordance with one or more formats. The formatting may be selected based on a role of a user or operator, presentation or communication devices that are available for use, etc.

In block 220d, the outputs generated as part of block 216d may be provided to one or more users or devices. As part of block 220d, the outputs may be presented (such as via a dashboard), saved/stored/recorded, edited, etc. Interactions involving the outputs may be provided as feedback, which in turn may result in an adaptation or modification of one or more of the models of block 204d. In this respect, and to the extent that any errors or inconsistencies are identified as part of block 220d, a determination may be made whether there is a correction or clarification that is capable of being identified. To the extent that such a correction/clarification is capable of being identified, the correction/clarification may be implemented as part of a modified or revised/retrained model, as applicable, as part of block 224d. In this manner, and as one of skill in the art will appreciate, aspects of the method 200d (inclusive of aspects of blocks 224d and 204d) may be executed iteratively/recursively and may tend to reduce a likelihood of any errors or inconsistencies being generated the more the method 200d is utilized, which is to say that any errors or inconsistencies may tend to converge towards zero over time. This reduction in error may encourage further adoption/utilization, which may tend to increase the rate of convergence towards zero. In brief, success may drive further success.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. In some embodiments, functionality or operations associated with a first of blocks may be based on functionality or operations associated with one or more of the other blocks.

As set forth above, the various aspects of this disclosure are integrated as part of numerous practical applications. Furthermore, the various aspects of this disclosure are representative of substantial improvements to technology. Aspects of this disclosure may facilitate a low-cost alternative to larger, licensed models, while incurring minimalistic loss in quality and accuracy. Furthermore, aspects of this disclosure may enable a firm, a user or operator, or the like, to manage data or information without the accompanying risk of exposure of confidential or privileged data/information, which in turn may enhance compliance with regulations or regulatory standards. In this respect, the various aspects and features of this disclosure address long-felt needs in the art that have gone largely unaddressed prior to this disclosure. Also, some or all of the entire solution framework may be designed and modularized, which can be replicated to any business use case with reduced (e.g., minimal) effort in development.

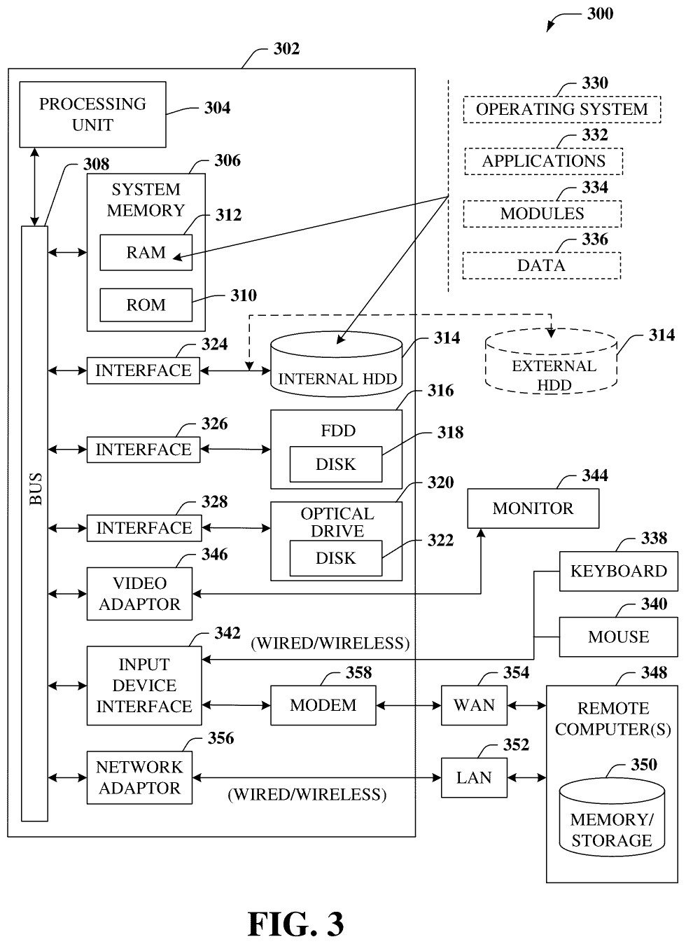

Turning now to FIG. 3, there is illustrated a block diagram of a computing environment in accordance with various aspects described herein. In order to provide additional context for various embodiments of the embodiments described herein, FIG. 3 and the following discussion are intended to provide a brief, general description of a suitable computing environment 300 in which the various aspects and embodiments of the subject disclosure can be implemented. For example, the computing environment 300 can facilitate, in whole or in part, obtaining a model, obtaining a document, processing the document based on the model, the processing of the document resulting in a classification of a type of the document, generating, based on the classification of the type of the document, a first output, the first output including a first summary of content of the document, and transmitting the first output to a first communication device. The computing environment 300 can facilitate, in whole or in part, obtaining a document. The computing environment 300 can facilitate, in whole or in part, obtaining, by a processing system including a processor, at least one input, processing the at least one input to generate an output, providing the output to a user equipment, receiving, based on the providing of the output, a query from the user equipment, analyzing the query via a model to generate an answer to the query, and providing the answer to the user equipment.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 3, the example environment can comprise a computer 302, the computer 302 comprising a processing unit 304, a system memory 306 and a system bus 308. The system bus 308 couples system components including, but not limited to, the system memory 306 to the processing unit 304. The processing unit 304 can be any of various commercially available processors. Dual microprocessors and other multiprocessor architectures can also be employed as the processing unit 304.

The system bus 308 can be any of several types of bus structure that can further interconnect to a memory bus (with or without a memory controller), a peripheral bus, and a local bus using any of a variety of commercially available bus architectures. The system memory 306 comprises ROM 310 and RAM 312. A basic input/output system (BIOS) can be stored in a non-volatile memory such as ROM, erasable programmable read only memory (EPROM), EEPROM, which BIOS contains the basic routines that help to transfer information between elements within the computer 302, such as during startup. The RAM 312 can also comprise a high-speed RAM such as static RAM for caching data.

The computer 302 further comprises an internal hard disk drive (HDD) 314 (e.g., EIDE, SATA), which internal HDD 314 can also be configured for external use in a suitable chassis (not shown), a magnetic floppy disk drive (FDD) 316, (e.g., to read from or write to a removable diskette 318) and an optical disk drive 320, (e.g., reading a CD-ROM disk 322 or, to read from or write to other high-capacity optical media such as the DVD). The HDD 314, magnetic FDD 316 and optical disk drive 320 can be connected to the system bus 308 by a hard disk drive interface 324, a magnetic disk drive interface 326 and an optical drive interface 328, respectively. The hard disk drive interface 324 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 302, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 312, comprising an operating system 330, one or more application programs 332, other program modules 334 and program data 336. All or portions of the operating system, applications, modules, and/or data can also be cached in the RAM 312. The systems and methods described herein can be implemented utilizing various commercially available operating systems or combinations of operating systems.

A user can enter commands and information into the computer 302 through one or more wired/wireless input devices, e.g., a keyboard 338 and a pointing device, such as a mouse 340. Other input devices (not shown) can comprise a microphone, an infrared (IR) remote control, a joystick, a game pad, a stylus pen, touch screen or the like. These and other input devices are often connected to the processing unit 304 through an input device interface 342 that can be coupled to the system bus 308, but can be connected by other interfaces, such as a parallel port, an IEEE 1394 serial port, a game port, a universal serial bus (USB) port, an IR interface, etc.

A monitor 344 or other type of display device can be also connected to the system bus 308 via an interface, such as a video adapter 346. It will also be appreciated that in alternative embodiments, a monitor 344 can also be any display device (e.g., another computer having a display, a smart phone, a tablet computer, etc.) for receiving display information associated with computer 302 via any communication means, including via the Internet and cloud-based networks. In addition to the monitor 344, a computer typically comprises other peripheral output devices (not shown), such as speakers, printers, etc.

The computer 302 can operate in a networked environment using logical connections via wired and/or wireless communications to one or more remote computers, such as a remote computer(s) 348. The remote computer(s) 348 can be a workstation, a server computer, a router, a personal computer, portable computer, microprocessor-based entertainment appliance, a peer device or other common network node, and typically comprises many or all of the elements described relative to the computer 302, although, for purposes of brevity, only a remote memory/storage device 350 is illustrated. The logical connections depicted comprise wired/wireless connectivity to a local area network (LAN) 352 and/or larger networks, e.g., a wide area network (WAN) 354. Such LAN and WAN networking environments are commonplace in offices and companies, and facilitate enterprise-wide computer networks, such as intranets, all of which can connect to a global communications network, e.g., the Internet.

When used in a LAN networking environment, the computer 302 can be connected to the LAN 352 through a wired and/or wireless communication network interface or adapter 356. The adapter 356 can facilitate wired or wireless communication to the LAN 352, which can also comprise a wireless AP disposed thereon for communicating with the adapter 356.

When used in a WAN networking environment, the computer 302 can comprise a modem 358 or can be connected to a communications server on the WAN 354 or has other means for establishing communications over the WAN 354, such as by way of the Internet. The modem 358, which can be internal or external and a wired or wireless device, can be connected to the system bus 308 via the input device interface 342. In a networked environment, program modules depicted relative to the computer 302 or portions thereof, can be stored in the remote memory/storage device 350. It will be appreciated that the network connections shown are example and other means of establishing a communications link between the computers can be used.

The computer 302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A computer apparatus for facilitating an information using an information miner using a language model, comprising:
a processing system including a processor; and
a memory that stores executable instructions that, when executed by the processing system, facilitate performance of operations, the operations comprising:
obtaining a model;
obtaining a document;
processing the document based on the model, the processing of the document resulting in a classification of a type of the document;
generating, based on the classification of the type of the document, a first output, the first output including a first summary of content of the document;
transmitting the first output to a first communication device, wherein the first communication device is associated with a first user having a first role;
generating, based on the classification of the type of the document, a second output, the second output including a second summary of the content of the document, wherein the second summary is different from the first summary; and
transmitting the second output to a second communication device associated with a second user, the second user having a second role.

2. The computer apparatus of claim 1, wherein the first summary of the content of the document is based on an identification of the first role of the first user within an organization.

3. The computer apparatus of claim 2, wherein the second summary of the content of the document is based on an identification of the second role of the second user within the organization, the second role being different from the first role.

4. The computer apparatus of claim 1, wherein the transmitting of the first output to the first communication device causes the first communication device to present the first output, store a copy of the first output, or a combination thereof.

5. The computer apparatus of claim 1, wherein the operations further comprise:
based on the classification of the type of the document, transmitting a query to the first communication device; and
obtaining, from the first communication device, an answer to the query,
wherein the generating of the first output is based on the answer.

6. The computer apparatus of claim 1, wherein the operations further comprise:
obtaining, from the first communication device, a query; and
generating an answer to the query based on the processing of the document.

7. The computer apparatus of claim 6, wherein the query is a free text query, wherein the answer is based on the type of the document, or a combination thereof.

8. The computer apparatus of claim 6, wherein the answer is included as part of the first output, a third output that is transmitted to the first communication device, or a combination thereof.

9. The computer apparatus of claim 8, wherein the operations further comprise:
generating a justification or an explanation for the answer,
wherein the justification or the explanation is included as part of the first output, the third output, or the combination thereof.

10. The computer apparatus of claim 1, wherein the processing of the document occurs in less than five minutes and the document is greater than 250 pages, and wherein the processing of the document extracts information that is context seated within text.

11. The computer apparatus of claim 1, wherein the operations further comprise:
subsequent to the transmitting, obtaining feedback from the first communication device based on the first output; and
modifying the model based on the feedback, the modifying resulting in a modified model.

12. The computer apparatus of claim 11, wherein the feedback modifies the first output, resulting in a modified output that is different from the first output.

13. The computer apparatus of claim 11, wherein the operations further comprise:
obtaining a second document;
generating, based on the modified model, a third output, the third output including a third summary of content of the second document; and
transmitting the third output to the first communication device, the second communication device, a third communication device, or any combination thereof.

14. The computer apparatus of claim 13, wherein the operations further comprise:
processing the second document based on the modified model, the processing of the second document resulting in a second classification of a type of the second document,
wherein the generating of the third output is based on the second classification of the type of the second document.

15. The computer apparatus of claim 1, wherein the operations further comprise:
formatting the first output based on a capability of the first communication device, the formatting resulting in a formatted first output,
wherein the transmitting of the first output comprises transmitting the formatted first output.

16. A non-transitory computer readable storage medium for facilitating an information using an information miner using a language model, the storage medium comprising executable instructions which, when executed by a processing system including a processor, facilitate performance of operations, the operations comprising:
obtaining a document;
determining that a first portion of the document includes structured data and a second portion of the document includes unstructured data;
processing, based on the determining, the first portion of the document using a first model to generate a first output;
processing, based on the determining, the second portion of the document using a second model to generate a second output; and
transmitting the first output and the second output.

17. The storage medium of claim 16, wherein the processing of the second portion includes condensing content associated with the unstructured data.

18. The storage medium of claim 16, wherein the processing of the first portion includes identifying a type of the document, summarizing content of the document, answering a set of cadence queries based on the type of the document, and answering a free text query obtained from a communication device.

19. A method for facilitating an information using an information miner using a language model, comprising:
obtaining, by a processing system including a processor, at least one input;
processing, by the processing system, the at least one input to generate an output;
providing, by the processing system, the output to a user equipment;
receiving, by the processing system and based on the providing of the output, a query from the user equipment;
analyzing, by the processing system, the query via a model to generate an answer to the query; and
providing, by the processing system, the answer to the user equipment.

20. The method of claim 19, wherein the at least one input includes a document, an audio file, a video file, an image, text, an e-mail, an instant message, a table, and a graph, wherein the processing of the at least one input utilizes the model, a second model, or a combination thereof, wherein the output includes a summary of content along with deep seated information and information from data tables of the at least one input, and wherein the summary is based on a role of a user associated with the user equipment.
